(19) United States
(12) Patent Application Publication
(10) Pub. No.: US 2014/0334991 A1
(43) Pub. Date: Nov. 13, 2014

(54) Thermally or Photochemically Activated Small Molecule Delivery Platform

(71) Applicant: Sandia Corporation, Albuquerque, NM (US)

(72) Inventors: Ross Stefan Johnson, Wilmington, DE (US); Shawn M. Dirk, Albuquerque, NM (US); Cody M. Washburn, Albuquerque, NM (US); Michael T. Dugger, Tijeras, NM (US)

(21) Appl. No.: 14/340,153

(22) Filed: Jul. 24, 2014

Related U.S. Application Data
(62) Division of application No. 13/851,595, filed on Mar. 27, 2013.

(51) Int. Cl. B01J 19/12

(52) U.S. Cl. CPC B01J 19/123; B01J 2219/1203
USPC 422/186.3

(57) ABSTRACT

Thermally or photochemically activated small molecule delivery polymers and platforms enable ‘on-demand’ delivery of a vapor-phase lubricant, such as pentanol or other alcohols, that enable scheduled or as-needed lubrication of MEMS devices, thereby greatly improving the reliability and lifespan of the devices.

### CROSS-REFERENCE TO RELATED APPLICATION

This application is a divisional application of co-pending non-provisional U.S. patent application Ser. No. 13/851,595 entitled “Thermally or Photochemically Activated Small Molecule Delivery Platform”, filed on Mar. 27, 2013, which is incorporated herein by reference. This divisional application and the parent application are related to U.S. application Ser. No. 13/034,535 entitled “Thermally Switchable Dielectrics”, filed on Feb. 24, 2011, which is also incorporated herein by reference.

### STATEMENT OF GOVERNMENT INTEREST

This invention was made with Government support under contract no. DE-AC04-94AL85000 awarded by the U.S. Department of Energy to Sandia Corporation. The Government has certain rights in the invention.

### FIELD OF THE INVENTION

The present invention relates to lubricants for microelectromechanical systems (MEMS) devices and, in particular, to a polymer and platform for delivering a thermally or photochemically activated small molecule to a MEMS device.

### BACKGROUND OF THE INVENTION

As the dimensions of electromechanical devices decrease, traditional lubrication approaches may be inappropriate or even result in damage to small parts. For example, deposition approaches for solid lubricants such as MoS₂ and graphite involve spraying of epoxy-solvent blends or physical vapor deposition in a vacuum chamber. Spraying and curing of liquid precursors make thickness difficult to control on small parts, and vacuum processes require that small parts be held and manipulated inside the chamber to insure uniform coating. Difficulties in handling small parts for lubrication is particularly evident in the case of microelectromechanical systems (MEMS), where millimeter-scale parts with micrometer-scale features are fabricated in the fully assembled state, making introduction of lubricants to specific parts after fabrication impossible. Lubrication by total immersion in fluid drastically reduces operating speed due to fluid damping, eliminating rapid change of state which is a major advantage of MEMS due to their low inertia. Mitigation of friction and wear in MEMS is crucial for improving performance and lifetimes, and will require new lubricants with properties tailored to the size of the moving components. Chemisorbed monolayers have been successful as processing aids by reducing capillary adhesion after fabrication and sacrificial layer etching, but do not survive repeated mechanical contact during operation. See W. R. Ashurst et al., Microelectromechanical Systems 10, 41 (2001); and D. A. Hook et al., J. Applied Physics 104, 034303 (2008). Vapor phase lubrication with alcohols has previously been shown to greatly reduce friction and wear on sliding surfaces. See S. H. Kim et al., Nano Today 2(5), 22 (2007). In particular, pentanol has been shown to be a promising lubricant for MEMS. See D. B. Asay et al., Tribol. Lett. 29, 67 (2008); and A. L. Barnette et al., Langmuir 26, 16299 (2010).

However, a need remains for the ‘on-demand’ delivery of vapor-phase lubricant, such as pentanol or other alcohols, that would enable scheduled or as-needed lubrication of MEMS components, thereby greatly improving the reliability and lifespan of the devices.

### SUMMARY OF THE INVENTION

The present invention is directed to a thermally or photochemically activated small molecule delivery polymer, comprising a polymer that releases an alcohol or halide upon heating or exposure to ultraviolet light. The polymer preferably comprises a precursor to poly(p-phenylene vinylene). For example, the precursor can comprise a xanthate or alkyloxy precursor polymer, such as a pentyl-xanthate or pentyloxy polymer, that releases pentanol.

The invention is further directed to a method for delivering a small molecule to a microelectromechanical systems device, comprising providing a microhotplate having a thermally activated small molecule delivery polymer deposited thereon and heating the polymer to above an elimination temperature, thereby releasing a small molecule. For example, the small molecule delivery polymer can comprise a precursor to poly(p-phenylene vinylene). For example, the precursor can comprise a xanthate precursor polymer or an alkyloxy precursor polymer that releases an alcohol, such as pentanol. Alternatively, the precursor can comprise a halogen precursor polymer that releases a halide.

The invention is further directed to a thermally or photochemically activated small molecule delivery platforms.

As examples of the invention, two polymers are described herein that are capable of delivering a lubricant (pentanol) to MEMS devices. In particular, utilizing precursor polymers to poly(p-phenylene vinylene) (PPV) allows for (1) a high loading of lubricant (1 molecule per monomeric unit) (2) a platform that requires relatively high temperatures (>145° C.) to eliminate the lubricant and (3) a non-volatile, mechanically and chemically stable bi-product of the elimination reaction (PPV). The polymer-microhotplate system can be integrated into MEMS devices, enabling high performance and lifetimes of the MEMS devices. The ability to assemble and store MEMS for prolonged periods of time and then deliver lubricant to the sealed device when needed reduces potentially undesirable interactions of the lubricant with the packaging components of the system. With improvements in lifetime gained by utilizing a lubricant, and the ability to internally deliver the lubricant ‘as-needed’, this type of delivery system may greatly improve the reliability and cost-effectiveness of MEMS.

### BRIEF DESCRIPTION OF THE DRAWINGS

The detailed description will refer to the following drawings, wherein like elements are referred to by like numbers.

FIG. 1 shows a method for the synthesis of a xanthate precursor polymer and the elimination of the xanthate group upon heating, thereby releasing carbon disulfide and alcohol.

FIG. 2A is a thermogravimetric analysis (TGA) and FIG. 2B is a variable temperature UV-Vis spectral analysis of the pentyl-xanthate polymer.

FIG. 3 shows a method for the synthesis of a 2-methoxy-5-hexoxy precursor polymer.

FIG. 4A is a TGA of the pentyloxy polymer. FIG. 4B is a NMR spectra of the pentyloxy polymer.

FIG. 5 shows the synthesis of halogen precursor polymers from halogen monomers, starting with a diol intermediate, and the release of an acid molecule upon heating of the halogen precursor polymer.

FIG. 6 shows the thermogravimetric analysis (TGA) of the halogen precursor polymers.

FIGS. 7A-7D show cross-sectional side-view illustrations of a method to fabricate a microhotplate. FIG. 7A illustrates deposition of contact pads on the device layer. FIG. 7B illustrates formation of the topside mechanical/electrical structure in the device layer. FIG. 7C illustrates formation of the device's thermal isolation features. FIG. 7D illustrates deposition of the thermally activated small molecule delivery polymer on the cantilevered suspended membrane.

FIG. 8 is a top-view illustration of a microhotplate.

FIG. 9A shows a GC analysis of the elimination products from the pentyl-xanthate polymer heated in the microhotplate. FIG. 9B shows a GC analysis of the elimination products from the pentyloxy polymer heated in the microhotplate.

### DETAILED DESCRIPTION OF THE INVENTION

The present invention is directed to the synthesis and characterization of polymer systems that release alcohol lubricants, for example pentanol, at elevated temperatures, and a microhotplate heater that can be used for ‘on-demand’ vapor phase lubrication for MEMS. In order to release an alcohol ‘on-demand’ to a MEMS device, a delivery system needs to be sufficiently robust to withstand not only environmental changes, but also the assembly and packaging conditions of the device. Therefore, the invention is more particularly directed to precursor polymers to poly(p-phenylene vinylenes) (PPV) where the leaving group acts as the lubricant. Using this type of system as a small molecule delivery platform has the advantages that (1) high temperatures (>145° C.) are required to eliminate the lubricant, making the delivery platform stable in most processing environments, (2) a high concentration of lubricant can be incorporated into the polymer (1 molecule of lubricant per repeat unit), and (3) the elimination byproduct is high molecular weight PPV, which is a non-volatile, mechanically stable solid. Although the examples below refer to thermally activated polymers, these same polymers can also release small molecules when exposed to ultraviolet light. Therefore, it is understood that an ultraviolet light source, rather than a microhotplate, can be used to release the small molecules from the polymer.

As examples of the present invention, two different polymer systems were designed, synthesized, and analyzed as pentanol delivery systems. The first example utilized a xanthate precursor polymer, which has been previously reported to eliminate the xanthate group forming carbon disulfide and ethanol. See S. Son et al., Science 269, 376 (1995); E. Kesters et al., Macromolecules 35, 7902 (2002); and R. S. Johnson et al., Chem. Commun. 47, 3936 (2011). According to this example, a re-design of the xanthate group to contain a pentyloxy side-chain enables the xanthate to eliminate into pentanol and carbon disulfide at high temperatures. The second example was based on literature reports that described the substitution of sulfonium precursor polymers with methanol and later butanol. See T. Momii et al., Chem. Lett., 1201 (1988); P. L. Burn et al., Synth. Met. 41, 261 (1991); P. L. Burn et al., J. Chem. Soc. Perkin Trans. 1, 3225 (1992); and C. C. Han and R. L. ElsenBaumer, Synth. Met. 30, 123 (1989). According to this example, substitution with pentanol provides a polymer capable of releasing the lubricant at elevated temperatures.

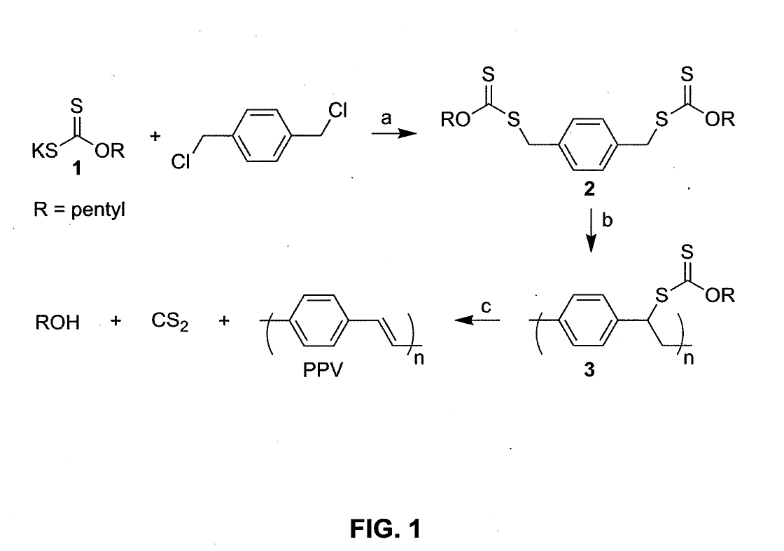

The first example is directed to the synthesis of a polymer with a xanthate group containing a pentyloxy side-chain that enables the xanthate to eliminate into pentanol and carbon disulfide at high temperatures. Synthesis of the pentyl-xanthate precursor polymer was based on previous literature reports. See S. Son et al., Science 269, 376 (1995); E. Kesters et al., Macromolecules 35, 7902 (2002); and R. S. Johnson et al., Chem. Commun. 47, 3936 (2011). As shown in FIG. 1, the xanthate salt 1 can be prepared from the reaction of a basified solution of pentanol and carbon disulfide. For example, KOH (10.02 g, 0.178 mol) can be added to 1-pentanol (103 mL) and stirred until fully dissolved. CS₂ (13.0 mL, 0.216 mol) can be added and a yellow precipitate formed. The reaction can be diluted with diethyl ether (60 mL) and stirred for 15 min before the precipitate is isolated by vacuum filtration. The product can be titrated in hexanes (100 mL) and isolated by vacuum filtration leaving a light beige colored solid (27.20 g, 82%) of potassium pentyl-xanthate 1. As shown at step (a), reaction of the xanthate with 1,4-bis(chloromethyl)benzene forms xanthate monomer 2. For example, 1,4-bis(chloromethyl)benzene (3.12 g, 17.8 mmol) and potassium pentyl-xanthate 1 (8.05 g, 39.8 mmol) can be vigorously stirred in methanol (115 mL) for 22 h. The methanol can be evaporated and the residue can be dissolved in 1:1 CHCl₃/H₂O (200 mL). The organic layer can be separated and the aqueous layer can be extracted three additional times with CHCl₃ (150 mL total). The combined organics can be dried over Na₂SO₄ and the solvent can be evaporated. The desired 1,4-bis[pentoxy(thiocarbonyl)thiomethyl]-benzene 2 product (C₂₀H₃₀O₂S₄, 6.45 g, 84%) is obtained as a pale yellow oil after column chromatography (0-1% EtOAc/hexanes). As shown at step (b), the monomer 2 can then be reacted with one equivalent of potassium t-butoxide to form the xanthate precursor polymer 3. For example, to a stirred solution of monomer 2 (2.01 g, 4.66 mmol) in anhydrous THF (20 mL) at 0° C. can be added t-BuOH (4.66 mL, 1.0 M) in several portions over a 1 min time period. After 20 min, the ice bath can be removed. The reaction can be stirred for 1.5 h total and poured over stirring ice water. The mixture can be extracted with CHCl₃ (4×25 mL). The combined organics can be dried over Na₂SO₄ and the solvent can be evaporated until 10 mL of solvent remains. The viscous solution can be poured over cold acetone (150 mL) yielding a brown gummy solid, which can be re-precipitated a second time using the same procedure. The polymer can be dissolved in dichloromethane and the solvent can be evaporated leaving a pale yellow foam (0.52 g, 41%) of poly{1,4-phenylene[1-pentoxy(thiocarbonyl)-thio]ethylene} 3. At step (c), the xanthate precursor polymer 3 can be heated to a temperature in excess of 225° C. to eliminate the xanthate group, thereby forming PPV and releasing carbon disulfide (CS₂) and alcohol (ROH). Alternatively, UV light can be used to release the small molecules.

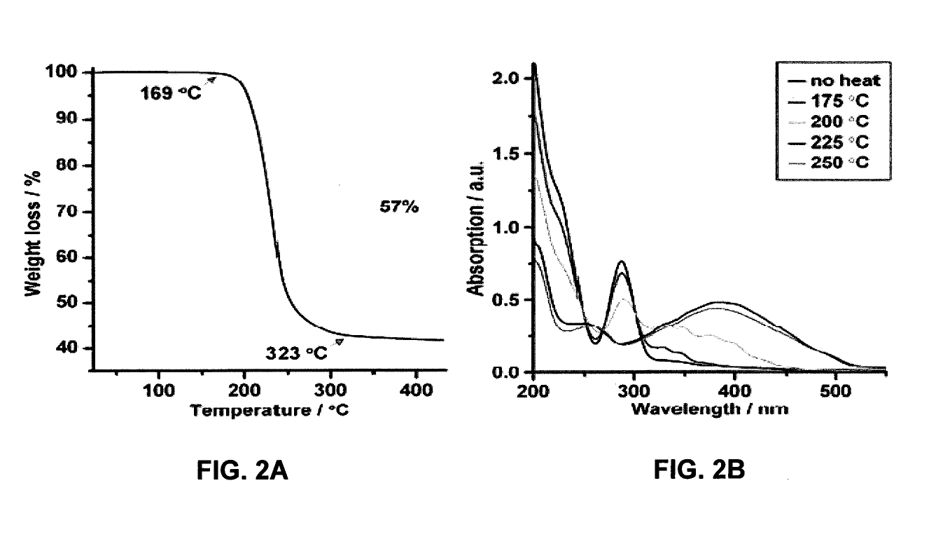

FIG. 2A is a TGA analysis of the xanthate polymer 3, indicating that the polymer begins losing mass at 169° C. and loses 57% of its mass by 323° C. The measured weight loss is slightly lower than the theoretically predicted value (61.6%), a result of a small amount of conjugation occurring during the synthesis. As shown in FIG. 2B, variable temperature UV-Vis analysis was performed to further investigate the elimination reaction. A solution of polymer 3 (2% wt/vol, CHCl₃) was spun coat onto a quartz slide. The UV-Vis spectrum was recorded and the sample was heated on a hot-plate for 30 min (in air) before the UV-Vis spectrum was again recorded; this procedure was repeated at 25° C. temperature increments until 250° C. The data shows the xanthate peak (˜290 nm) begins to reduce in intensity after the polymer is subjected to 175° C., but does not fully eliminate until 225° C. The band centered at ˜390 nm is a result of π-π* transitions along the conjugated polymer backbone, and confirms that PPV is forming as a byproduct of the elimination reaction. The variable temperature UV-Vis experiment indicates that xanthate polymer 3 needs to be heated to 225° C. to fully eliminate the xanthate groups and release the maximum amount of lubricant to a MEMS device.

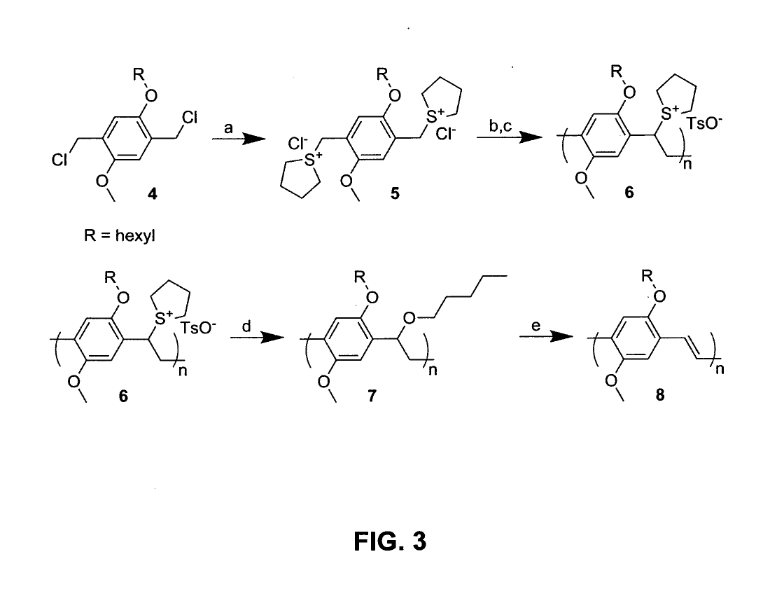

According to the second example, substitution of a sulfonium precursor polymer with a desired small molecule (e.g., pentanol) provides a polymer capable of releasing the lubricant at elevated temperatures. To increase both the solubility of the precursor polymer in pentanol and the reactivity towards substitution, a 2-methoxy-5-hexoxy precursor polymer was synthesized, as shown in FIG. 3. 2-5-bis(chloromethyl)-1-hexoxy-(4-methoxy)benzene 4 was synthesized based on previously reported literature procedures. See P. C. Marr et al., Synth. Met. 102, 1081 (1999); and S. Chelli et al., J. Polym. Sci. Part A: Polym. Chem. 47, 4391 (2009). As shown at step (a), reaction with tetrahydrothiophene produces sulfonium monomer 5, which can be polymerized in aqueous NaOH and precipitated from solution with excess sodium tosylate. See T. Momii et al., Chem. Lett. 1201 (1988); P. L. Burn et al., Synth. Met. 41-43, 261 (1991); and P. L. Burn et al., J. Chem. Soc. Perkin Trans. 1, 3225 (1992). For example, to a suspension of 2-5-bis(chloromethyl)-1-hexoxy-(4-methoxy) benzene (1.47 g, 4.81 mmol) in a MeOH (30 mL)/water (7.3 mL) solution can be added tetrahydrothiophene (1.30 mL, 14.7 mmol). The reaction can be stirred for 20 h at 50° C. and the majority of the solvent can be evaporated to provide 2-methoxy-5-hexoxy-p-xylyene bis(tetrahydrothiophenium chloride) 5. At step (b), to a solution of monomer 5 (1.06 g, 2.20 mmol) in water (12 mL) and acetone (5 mL) at 0° C. can be added a NaOH solution (4.40 mL, 0.050 M) over 10 min. After 2.5 h of stirring at 0° C., sodium p-toluenesulfonate (excess) can be added and vigorously stirred at step (c), forming a white gummy precipitate 6, which can be isolated by decanting the solvent. The precipitate can be washed with water (35 mL) before adding 1-pentanol (35 mL) at step (d). The reaction can be stirred for 40 h at 40° C. The light yellow/green colored reaction solution can be poured over MeOH (150 mL, 0° C.) and the mixture can be centrifuged. The recovered solid can be dissolved in DCM (10 mL) and precipitated into MeOH (60 mL, 0° C.) forming a gummy pale yellow solid of poly[(2-methoxy-5-hexoxy)-p-phenylene-(1-pentoxyethylene)] 7, which can be dried under vacuum (0.107 g, 15%). The pentyloxy polymer 7 can then be heated or exposed to UV light at step (e) to release the pentanol. Alternatively, the sulfonium group of the sulfonium precursor polymer 6 can be replaced with small molecules other than pentanol at step (d) to release the desired small molecule at step (e).

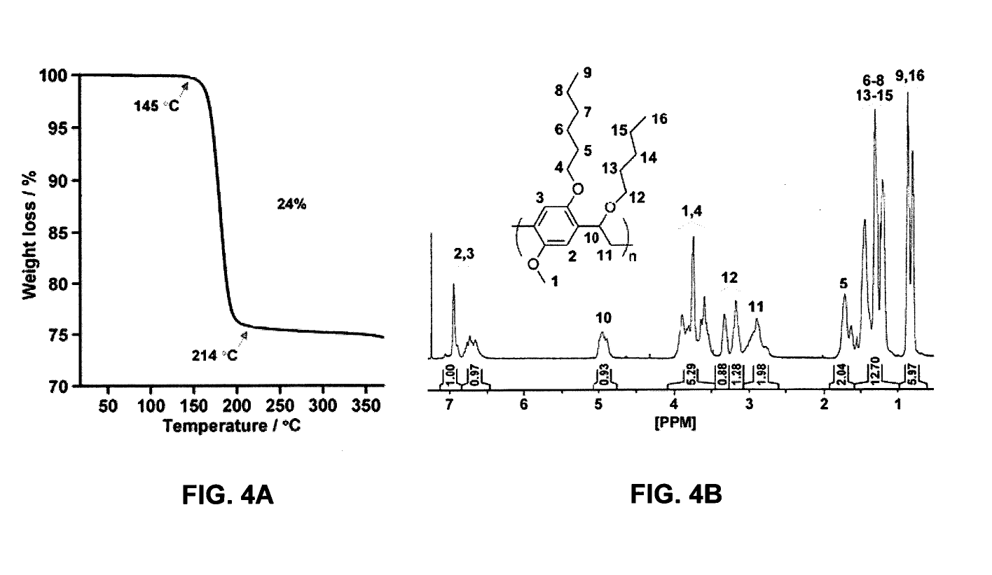

Pentyloxy polymer 7 was found to be soluble in common organic solvents, an initial indication that substitution of the sulfonium group had proceeded. As shown in FIG. 4A, TGA analysis of polymer 7 shows a single, sharp weight loss from 145° C. to 214° C. The polymer loses 24% of its mass, slightly lower than the theoretical value (27%) for eliminating pentanol, indicating a small amount of conjugation occurs during the synthesis and/or substitution reaction. As shown in FIG. 4B, NMR analysis of polymer 7 is consistent with the desired structure (integration of the alkoxy groups suggested a near complete substitution of the sulfonium groups with pentanol). XPS analysis of polymer 7 (data not shown) showed no trace of sulfur, also indicating the substitution reaction went to completion.

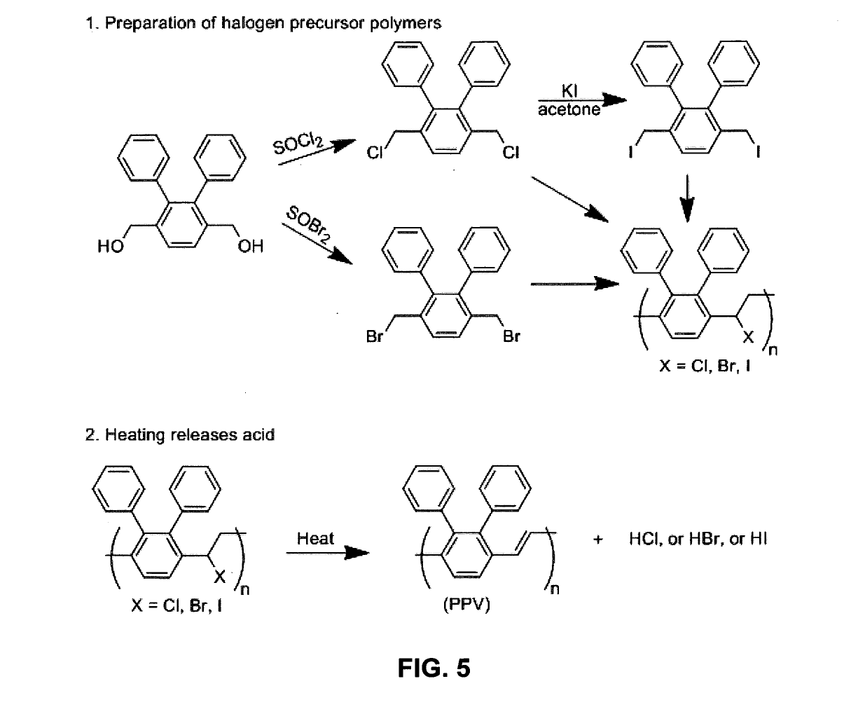

Other precursor polymer systems can also be used to release small molecules. For example, the related U.S. application Ser. No. 13/034,535 describes the synthesis of halogen precursor polymers that can be used to release acids at high temperatures, as shown in FIG. 5. The halogen precursor polymer is formed by reaction of the diol intermediate with a desired halide to form a halogenated monomer which is subsequently polymerized to form the halogen precursor polymer. Heating of the halogen precursor polymer releases the acid (HX) from the PPV polymer.

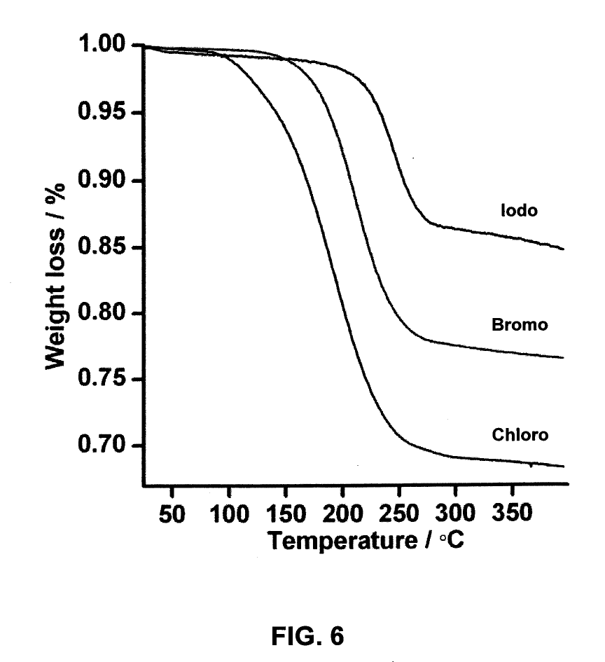

As shown in FIG. 6, thermogravimetric analysis (TGA) was performed to determine the temperatures at which the halogens eliminated. It was found that the onset of elimination occurred at 180° C. for the chloro polymer, 137° C. for the bromo polymer, and 90° C. for the iodo polymer, indicating the relative decrease in carbon-halogen bond strengths. It was estimated that the chloro polymer underwent a 12.3% mass loss (12.5% expected theoretically), the bromo polymer underwent a 21.4% mass loss (24.1% expected theoretically), and the iodo polymer underwent a 30.1% mass loss (33.5% expected theoretically), consistent with the loss of the corresponding halide (HX).

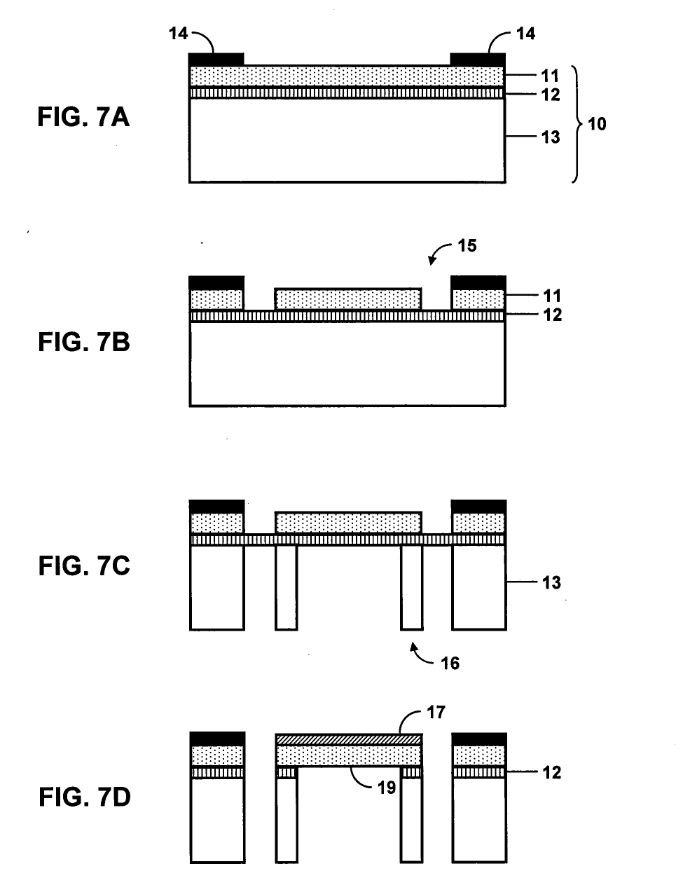

A microhotplate device capable of heating to high temperatures and run through multiple heating cycles can be used to release alcohol. A microhotplate similar to the one described by Manginell and Frye-Mason was used to evaluate the two exemplary polymer systems, except that heavily doped silicon as the basis for its resistive heating elements and structural material. See R. Manginell and G. Frye-Mason, U.S. Pat. No. 6,527,835, which is incorporated herein by reference. A cross-sectional side-view illustration of a method to fabricate a microhotplate starting from a silicon-on-insulator (SOI) wafer 10 is illustrated in FIGS. 7A-7D. As shown in FIG. 7A, Al with 1% Si can be sputter deposited to a thickness of 1 μm onto a heavily doped Si device layer 11 to form contact pads 14. Following deposition, a 450° C. forming gas annealing step can performed to assure intimate contact between the pads and the Si device layer. As shown in FIG. 7B, the topside mechanical/electrical structure 15 can be formed in the device layer 11 via lithographic patterning followed by a plasma etch that stops on the buried oxide layer 12. As shown in FIG. 7C, lithography and a backside plasma etch of the silicon substrate 13 can define a “cup” structure 16 and the device's thermal isolation features. As shown in FIG. 7D, a final oxide removal step can be performed via plasma etching to completely release the cantilevers from the remaining buried oxide. Finally, the thermally activated small molecule delivery polymer 17 can be deposited on the cantilevered suspended membrane 19.

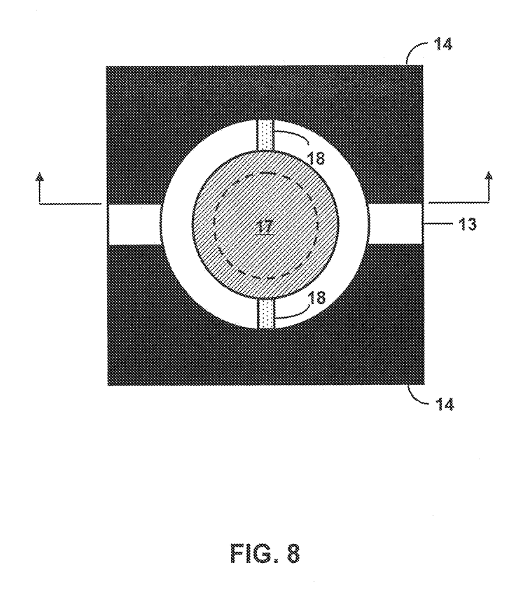

FIG. 8 is a top-view illustration of the microhotplate, showing the polymer 17 and contact pads 14 deposited on the suspended membrane and the cantilevers 18 suspending the membrane.

The SOI wafers used to create the exemplary microhotplates had a 10 μm thick, p-type device layer with a resistivity of 0.005-0.020 ohm-cm and a handle thickness of 400 μm. Electrical conduction through patterned device-layer silicon provides the joule heating that brings the microhotplate to temperature. Temperatures in excess of 700° C. have been recorded using IR thermography on these devices, with the areas of highest temperature being the cantilever struts. The microhotplate's cantilever structure is designed to minimize the thermal-mechanical stresses that arise when the structure is under a thermal load. Compared to metal wiring, the heavily-doped silicon provides a current conduction path whose resistance is stable over many thermal cycles, in part due to the resistance of the silicon conduction path to oxidation.

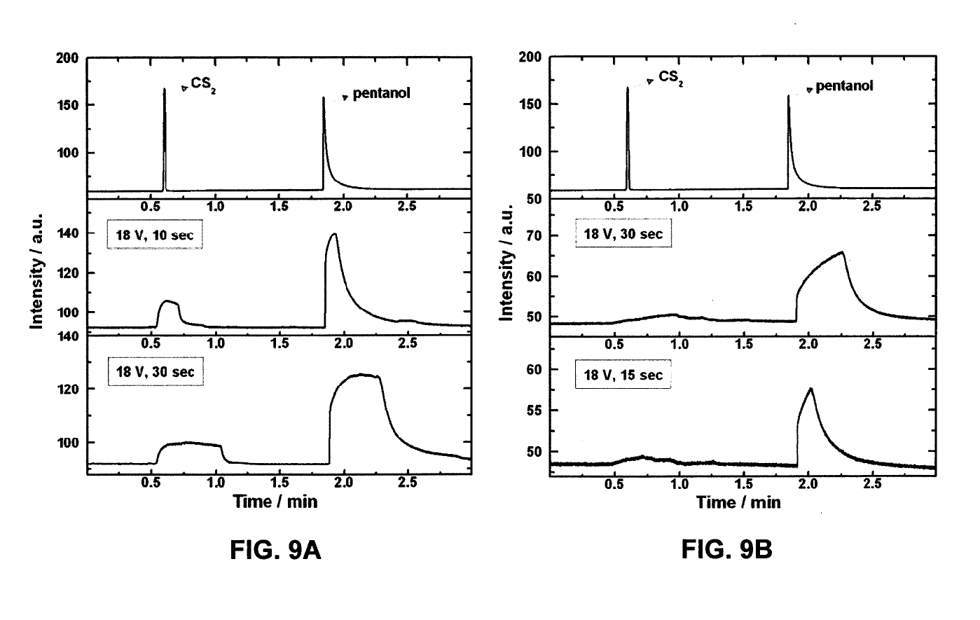

To determine the amount of voltage required to heat the polymer to temperatures high enough to eliminate the lubricant, gas chromatography (GC) analysis was performed. Both polymers (3 and 7) were dissolved in 1,2-dichloroethane (2.5% w/v), applied to a microhotplate, air dried for 1 h, and dried under vacuum for 14 h. The polymer-containing microhotplate was then placed in a small sealable fixture that contained GC column connections as well as electrical connections for applying voltage. A run was electronically triggered by applying a voltage pulse to the microhotplate. Control samples (carbon disulfide/pentanol), were run to gauge the elution times through the column (Rtx®-1, ˜12 m). As shown in FIG. 9A, the pentyl-xanthate polymer 3 showed two peaks, whose elution times corresponded well to the standards. As shown in FIG. 9B, the pentyloxy polymer 7 showed a major peak corresponding to the elution time of pentanol. A low-intensity, broad peak was also observed starting at 0.5 sec, which was also present in a control sample run with no polymer, and is thus attributed to either a volatile impurity on the hotplate or the non-temporal heating of the carrier gas. The amount and duration of voltage was varied to better understand the reaction kinetics (voltages of 10, 12.5, 15, and 18 volts were applied for durations of 1, 5, 10, 15, and 30 seconds). It was found that short duration, higher voltage pulses gave sharper peaks through the GC. By increasing the duration of the voltage pulse, the peaks broadened significantly, indicating that more of the elimination products were released. After performing multiple runs on the same sample, the intensity of the peaks greatly decreased, indicating the polymer was running out of lubricant to release. The elution time for the peaks also began to increase slightly after subsequent runs, which is attributed to the increased energy required to eliminate the remaining leaving groups (also observed in the UV-Vis and TGA studies). The results clearly show the polymers give off the predicted elimination products, and demonstrate that on-demand delivery of pentanol is possible, as the polymers can be heated multiple times releasing additional lubricant as needed.

While both polymer systems decompose to evolve pentanol at high temperatures, each system has specific advantages. The pentyl-xanthate polymer is more readily synthesized, but releases carbon disulfide and pentanol during elimination. The ability of carbon disulfide to serve as a lubricant for MEMS has not yet been examined; however, sulfur-containing additives are commonly used in extreme-pressure lubricants, and carbon disulfide has previously been demonstrated to increase the seizure load of an iron-iron surface contact. See L. O. Farng, in Lubricant Additives: Chemistry and Applications, 2^{nd} ed., (Ed: L. R. Rudnick), CRC Press, Boca Raton, Fla., Ch. 8 (2009); and J. Lara et al., Wear 239, 77 (2009). Because of the low flash-point of carbon disulfide (−30° C.), packaging the MEMS device in an inert atmosphere would likely be necessary to prevent ignition of the vapor while the MEMS device is operating. Synthesis of the pentyloxy polymer is comparatively lengthy and low-yielding;

however, elimination of solely pentanol increases the flash-point of the vapor lubricant (49° C.) and reduces toxicity associated with carbon disulfide. Comparing the performance and lifetime of MEMS devices lubricated with the pentyloxy polymer to the pentyl-xanthate polymer will help elucidate the effect of carbon disulfide.

The present invention has been described as a thermally or photochemically activated small molecule delivery polymers and platforms. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A thermally activated small molecule delivery platform, comprising:
a microhotplate; and
a thermally activated small molecule delivery polymer deposited on the microhotplate that releases a small molecule when heated above an elimination temperature by the microhotplate.

2. A photochemically activated small molecule delivery platform, comprising:
an ultraviolet light source; and
a photochemically activated small molecule delivery polymer that releases a small molecule when exposed to ultraviolet light from the ultraviolet light source.

3. The platform of claim 1 or 2, wherein the small molecule delivery polymer comprises a precursor to poly(p-phenylene vinylene).

4. The platform of claim 3, wherein the precursor comprises a xanthate precursor polymer or an alkyloxy precursor polymer.

5. The platform of claim 4, wherein the small molecular comprises an alcohol.

6. The platform of claim 5, wherein the alcohol comprises pentanol.

7. The platform of claim 3, wherein the precursor comprises a halogen precursor polymer.

8. The platform of claim 7, wherein the small molecule comprises a halide.
